(19) United States
(12) Patent Application Publication
(10) Pub. No.: US 2016/0095077 A1
(43) Pub. Date: Mar. 31, 2016

(54) NEW TDD FRAME STRUCTURE FOR UPLINK CENTRALIZED TRANSMISSION

(71) Applicant: INTELLECTUAL DISCOVERY CO., LTD., Seoul (KR)

(72) Inventors: Jinsam KWAK, Uiwang-si (KR); Juhyung SON, Uiwang-si (KR)

(73) Assignee: INTELLECTUAL DISCOVERY CO., LTD., Seoul (KR)

(21) Appl. No.: 14/787,878

(22) PCT Filed: Apr. 30, 2014
(86) PCT No.: PCT/KR2014/003884

§ 371 Date: Oct. 29, 2015

(30) Foreign Application Priority Data
Apr. 30, 2013 (KR) 10-2013-0048983
Apr. 30, 2013 (KR) 10-2013-0048985

(51) Int. Cl. H04W 56/00; H04W 72/04; H04L 5/14

(52) U.S. Cl. CPC H04W 56/0015; H04L 5/14; H04W 72/0413; H04W 72/0453

(57) ABSTRACT

The present disclosure relates to a wireless communication system, and more particularly to a method for transmitting synchronization channel and cell search signal in wireless communication system. Synchronization channel and cell search signal allow a terminal in a multi-layer cell supporting multiple carriers to effectively search and distinguish cells at different frequencies. To minimize terminal power consumption, new cell search signal transmission method proposes that base station connected at a frequency be used for transmitting information by other base stations at different frequencies, thereby allowing the terminal to readily recognizing neighbor cells and to determine about performing additional cell search. For the multi-layer cell to clearly distinguish cell identifications including inter-frequency measurement information, a cell ID pair between macro/small cells is proposed, achieving enhanced small cell efficiency. An uplink centralized transmission frame supports a multi-layer cell based on TDD, proposing a method for configuring synchronization signal in corresponding frame.

### TECHNICAL FIELD

The present disclosure relates to wireless communications. More particularly, the present disclosure relates to a method for acquiring and detecting a synchronization signal for a small cell.

### BACKGROUND

A Third Generation Partnership Project (3GPP) wireless communication system based on wideband code division multiple access (WCDMA) radio access technology has been widely deployed throughout the world. High speed downlink packet access (HSDPA), which can be defined as the first evolutionary step of WCDMA, provides 3GPP with a wireless connection technology with having a competitiveness in the near future.

There is an evolved universal mobile telecommunication system (E-UMTS) intended to provide a competitive edge in the future. Having evolved from existing WCDMA UMTS, the E-UMTS is in the process of standardization in the 3GPP. The E-UMTS is also referred to as a Long Term Evolution (LTE). For more information on the UMTS and E-UMTS Technical Specifications, reference can be made to “3rd Generation Partnership Project; Technical Specification Group Radio Access Network” Release 8 or later.

The E-UMTS generally involves a user terminal or equipment (UE), a base station and an access gateway (AG) located at an end of a network (E-UTRAN) and is connected to an external network. Typically, the base station can transmit multiple data streams at the same time for the purpose of a broadcast service, a multicast service and/or a unicast service. The LTE system utilizes an Orthogonal Frequency Divisional Multiplexing (OFDM) and multi-antenna Multiple Input Multiple Output (MIMO) to perform downlink transmission for a variety of services.

The OFDM is a high-speed downlink data access system. It has an advantage of high spectral efficiency, whereby all allocated spectrums can be used by all base stations. A transmission band for an OFDM modulation is divided into multiple orthogonal subcarriers in frequency domain and into a plurality of symbols in time domain. The division of transmission bands in the OFDM into multiple orthogonal subcarriers enables the deduction of the bandwidth for each subcarrier and increasement of the modulation time for each carrier wave. The plurality of subcarriers are transmitted in parallel and therefore digital data or symbol transmission rates of a particular subcarrier are lower than those of the single carrier.

The multi-antenna or the MIMO system is a communication system using multiple transmit and receive antennas. With increasing number of transmit and receive antennas, the MIMO system can linearly increase the channel capacity without bandwidth extension. MIMO technology adopts a spatial diversity scheme that can enhance the reliability of transmission by utilizing symbols passing through a variety of channel paths and a spatial multiplexing scheme for increasing the transmission rate with a plurality of transmit antennas respectively transmitting separate data streams at the same time.

The MIMO technology can be classified into an open-loop MIMO technology and closed-loop MIMO technology depending on whether the transmitting end possesses a channel information. The transmitting end in the open-loop MIMO has no knowledge of the channel information. Examples of the open-loop MIMO technology include PARC (per antenna rate control), PCBRC (per common basis rate control), BLAST, STTC, random beamforming and the like. On the other hand, the transmitting end in the closed-loop MIMO technology possesses the channel information. The performance of the closed-loop MIMO system is dependent on the accuracy of knowledge about the channel information. Examples of the closed-loop MIMO technology include PSRC (per stream rate control), TxAA and the likes.

The channel information refers to information on a radio channel (e.g., attenuation, phase shift or time delay, etc.) between multiple transmit antennas and multiple receive antennas. The MIMO system establishes a variety of stream paths through combinations of a plurality of transmission and receive antennas and has fading characteristics by which the channel state shows an irregular time variation in time/frequency domain due to multipath time delay. Therefore, the transmitting end calculates the channel information via channel estimation. The channel estimation is designed to estimate the channel information needed to reconstruct the transmitted signal after distortion. For example, the channel estimation refers to estimating the magnitude and reference phase of a carrier wave. In other words, the channel estimation serves to estimate the frequency response of the radio band or the wireless channel.

Transmission of control signals in time, spatial and frequency domains is essential to implementing various transmission or reception techniques for high-speed packet transmission. A channel for transmitting control signals is called a control channel. There may be various kinds of uplink control signals including an acknowledgement (ACK)/negative-acknowledgement (NACK) signal, which is a response to downlink data transmission, a channel quality indicator (CQI) for indicating a downlink channel quality, a precoding matrix index (PMI), and a rank indicator (RI).

In the 3GPP LTE system, synchronization signals are transmitted through a primary synchronization channel (P-SCH) and a secondary synchronization channel (S-SCH). A terminal may acquire a slot synchronization by using a primary synchronization signal (PSS) transmitted through the P-SCH. The terminal may acquire a frame synchronization by using a secondary synchronization signal (SSS) transmitted through the S-SCH. In addition, the terminal obtains an information on a cell ID. The terminal performs the synchronization through the P-SCH and S-SCH in an initial cell search process which is initially performed after the terminal is turned on, and a non-initial cell search process, in which the terminal performs a handover or a neighbor cell measurement.

### DISCLOSURE

### Technical Problem

Therefore, the present disclosure provides a method for transmitting a synchronization signal suitable for a small cell for an inter-frequency measurement.

The present disclosure further provides a method for configuring a synchronization channel for accurately and quickly acquiring an inter-cell information in an environment where a small cell and a macro cell coexist.

Evolutional performance improvement of existing systems is preferred over a new system definition for the ever-changing communication technology as a way of achieving the objectives. In particular, a communication system has ample influences not just on RF interfaces of terminals or base stations but also on all infrastructure facilities, and therefore minimizing the change of the system would be critical in the commercial point of view. In this context, a new version of communication system should have a limitation to maintain the main feature of the existing system. Particularly, an important requirement is to provide the functionality of the new system without degrading the performance of the existing system, which has been applied to LTE/LTE-A release 8/9/10 or later versions. The same requirement also applies to IEEE 802.16m and other communication systems when they are required to ensure the legacy systems. The performance improvement basically involves techniques including increasing the modulation order or the number of antennas and reducing the effects of interference.

In various cell topologies such as a femtocell and a picocell having cell coverage of less than 100 m, the wireless channel delay characteristics experienced by each cell are different from those of cells with larger coverages, which makes it desirable to design the control channel structure taking into account the two channel characteristics.

1) Frequency selectivity of the wireless channel: In the wireless channel characterized by delay spread, signals are received through multiple paths with various delay times. Thereby, the wireless channel has a delay profile defined by a plurality of delays, not defined by an impulse function. This fails to provide a constant channel gain, but causes a channel to be changed in frequency domain, which is referred to have a frequency selectivity. Small cells, characterized by their small coverage and the mostly indoor environment, are different in channel characteristics from a relatively poor environment of the mobile communications and may reduce the delay spread time to a few nanoseconds. This means that the frequency selectivity is insignificant and causes a large coherent bandwidth, resulting in similar channel characteristics between neighboring subcarriers.

2) Time selectivity of the wireless channel: In order to reduce the occurrence of frequent handover due to the configuration of small cells, small cells are appropriately used by pedestrians or stationary users, and accordingly mobility of the terminal may be restricted to slow-moving/stationary terminals. This mitigates the Doppler effect that affects the change of the wireless channel and causes the time selectivity of the radio channel different from that of fast-moving objects and then leads to a reduced channel variation between neighboring symbols. This prolongs the coherent time and results in a reduced channel variation between temporally neighboring subcarriers.

In addition to the advantage of time-frequency channel variation, the small cell may operate at different independent frequencies, and may coexist with the macro cell despite an overlapping coverage. The terminal performs a handover or a cell reconfiguration through a cell search process for each of carriers operating at different frequencies. The terminal may unnecessarily perform search processes for irrelevant frequency cells even without a neighbor small cell base station, resulting in a drastically reduced power efficiency. In addition, the denser the small cells are, the greater the power consumption is, and it becomes difficult to search a large number of small cells at the same time. Accordingly, there is a need for a method for readily performing cell search at different frequencies in order to efficiently manage the small cells.

If a small cell overlaps a macro cell and is controlled through the macro cell, a search/measurement information of a terminal that have searched and found the small cell may be transmitted to a macro base station. In this case, if the same small cell ID is shared by the corresponding macro cell or a neighbor cell, the macro base station may experience a difficulty in distinguishing therebetween. Therefore, there is a need for an ability to facilitate the small cell search and to simultaneously acquire an information on the controlling macro cell of the relevant small cell.

Therefore, some embodiments of the present disclosure provide a method for configuring a synchronization channel for searching a small cell over coexisting small and macro cells, a method for transmitting an additional cell search information, and a signaling method thereof.

In particular, a method is provided in 3GPP LTE-A Release 12, for configuring and transmitting a synchronization channel in a multi-layer cell in which a macro cell and a femtocell/picocell coexist.

At least one embodiment of the present disclosure provides a method for configuring a synchronization information specific to a small cell-supporting terminal and a method for transmitting a new synchronization channel.

At least one embodiment of the present disclosure provides a method for transmitting/receiving a new synchronization channel that has a backward compatibility and does not affect legacy terminals when expanding the synchronization channel, and a signaling method thereof.

At least one embodiment of the present disclosure provides a method for configuring a frame in a communication system for supporting an uplink centralized transmission, the method including generating a frame by periodically allocating an uplink switch subframe, and allocating all subframes to uplink except the switch subframe without involving a downlink-dedicated subframe.

The periodic allocation of the switch subframes may be defined as the period of 5 msec or 10 msec, and eight or nine of the uplink-dedicated subframes may be allocated in a frame. The number of downlink symbols within the switch subframe may be greater than or equal to 10, and all downlink synchronization information may be transmitted within the switch subframe.

At least one embodiment of the present disclosure provides a method for transmitting a downlink synchronization channel in a communication system for supporting an uplink centralized transmission, including allocating a subframe switched from a downlink to an uplink; configuring ten or more downlink symbols in the allocated subframe, and generating a synchronization signal by selecting two downlink symbols from among the allocated downlink symbols.

The symbols for transmission of the synchronization signal may be symbols on which neither a downlink control signal nor a reference signal is transmitted, and be selected from among symbol indexes 2, 3, 5 and 6. The synchronization signal may include 3GPP PSS and SSS, the interval between the symbols thereof may not be 2, and the transmitted synchronization signal may include an information indicating a UL centralized subframe.

Objects of the present disclosure are not limited to the aforementioned technical matters, and other unmentioned objects of the present disclosure will become apparent to those having ordinary skill in the art from the following description.

### SUMMARY

In accordance with some embodiments of the present disclosure, a cellular communication system including a plurality of base stations operating at different frequencies includes (i) allocating, by a first base station, downlink subframes for a second base station, (ii) generating, by the second base station, a signal to transmit through the allocated subframes, and (iii) transmitting the generated signal through the allocated subframes for a terminal connected to the first base station. The allocating of the downlink subframes is performed by using an MBSFN subframe, and the allocated subframe is in a frequency band used by the first base station. The signal of the second base station is transmitted by being mapped to a specific radio resource in the allocated subframes in consideration of an operating frequency band of the second base station, wherein the terminal connected to the second base station stops transmission and reception in a signal transmission interval in the first base station band of the second base station.

In accordance with some embodiments of the present disclosure, a cellular communication system including a plurality of base stations operating at different frequencies includes (i) allocating, by a first base station, an uplink radio resource for a second base station, (ii) generating, by a terminal, a signal to transmit for the second base station through the allocated resource, and (iii) transmitting, by the terminal, the generated signal through the radio resource of the first base station. The uplink radio resource uses a part of PUCCH or PUSCH, and a signal transmitted through the PUCCH has the same structure as PUCCH Format1, and is generated by the terminal through a time spread code[1, 1, −1, −1]. In addition, the signal for the terminal to transmit is intended to provide an information for activating the second base station. The signal for the terminal to transmit is intended to provide an information needed for the second base station to measure the strength of a received signal including an interference signal of the terminal.

In accordance with some embodiments of the present disclosure, a method for transmitting a synchronization channel for cell search in a communication system supporting a plurality of multi-layer base stations includes (i) generating a frame for generating and transmitting a synchronization signal of a first base station, (ii) allocating, in the frame of the first base station, a radio resource for a transmission of a synchronization information of a second base station, and (iii) transmitting a part of the synchronization information of the second base station through the allocated resource. The synchronization signal of the first base station includes a 3GPP LTE PSS and SSS, and the part of the synchronization information of the second base station is transmitted by selecting one of the PSS and the SSS of the second base station. The part of the synchronization information of the second base station includes PCID mod 6 as a cell ID of the second base station, and the synchronization signal of the first base station additionally transmits a base station information by applying a specific scrambling code to the PSS or SSS.

In accordance with some embodiments of the present disclosure, a method for configuring a frame in a communication system supporting an uplink centralized transmission, includes generating a frame by periodically allocating an uplink/downlink switch subframe, and allocating all subframes to uplink as uplink-dedicated subframes except the uplink/downlink switch subframe without a downlink-dedicated subframe. A period of the periodically allocating of the uplink/downlink switch subframe is defined as 5 msec or 10 msec, and eight or nine of the uplink-dedicated subframes are allocated in the frame. In addition, the number of downlink symbols in the uplink/downlink switch subframe is greater than or equal to 10, and all downlink synchronization information is transmitted within the uplink/downlink switch subframe.

In accordance with some embodiments of the present disclosure, a method for transmitting a downlink synchronization channel in a communication system supporting an uplink centralized transmission, includes (i) allocating a subframe switching from downlink to uplink, (ii) configuring at least ten downlink symbols in the allocated subframe, and (iii) generating a synchronization signal by selecting two symbols from among the allocated downlink symbols. The synchronization signal has a transmission symbol which is transmitted through symbols unused for transmissions of a downlink control signal and a reference signal. The transmission symbol of the synchronization signal is selected from among symbol indexes 2, 3, 5 and 6. The synchronization signal includes a 3GPP PSS and SSS having respective symbol spaces not equal to two symbols, and the transmission symbol of the synchronization signal contains an information indicating an uplink centralized subframe.

### Advantageous Effects

According to some embodiments of the present disclosure, at least the following effects are provided.

According to at least one embodiment, a radio resource efficiency and a terminal power usage efficiency are improved with respect to detecting a small cell along with cells in heterogeneous layers.

According to at least one embodiment, multiple base stations supporting multiple carriers consume less power for multi-carrier cell search with enhanced power efficiency in the base stations.

According to at least one embodiment, confusion of IDs between those of a macro cell and a small cell may not occur, and the small cell may be effectively controlled through the macro cell.

According to at least one embodiment, frequency resource efficiency of the macro and small cells may be enhanced through a frame configuration with a high proportion for uplink in TDD.

Effects that can be obtained from the present disclosure are not limited to the aforementioned, and other effects may be clearly understood by those skilled in the art from the descriptions given below.

### BRIEF DESCRIPTION OF DRAWINGS

To facilitate understanding of the present disclosure, the accompanying drawings included as part of the detailed description provide some embodiments of the present disclosure and an explanation of the technical idea of the present disclosure in conjunction with the detailed description.

FIG. 1 is a diagram of the structure of a radio frame used in 3GPP LTE.

FIG. 2 is a diagram of a resource grid for one downlink slot.

FIG. 3 is a diagram of the structure of a downlink radio frame.

FIG. 4 is a diagram of a configuration of an FDD-based downlink synchronization channel in 3GPP LTE Release 8 and later versions.

FIG. 5 is a diagram of a configuration of a TDD-based downlink synchronization channel in 3GPP LTE Release 8 and later versions.

FIG. 6 is a diagram of frequency-domain mapping for a transmission of PSS.

FIG. 7 is a diagram of frequency-domain mapping for a transmission of SSS.

FIG. 8 shows common scenarios for small cells.

FIG. 9 is a diagram of a scenario in which unnecessary power consumption by a terminal occurs in a small cell search process.

FIG. 10 is a diagram of a small cell search signal transmission structure of macro and small cells operating at different frequencies.

FIG. 11 is a diagram of a series of processes for small cell search by a terminal utilizing small cell-specific resources proposed in a macro/small cell environment.

FIG. 12 is a diagram of a macro/small cell transmission structure based on a terminal supported wake-up signal transmission.

FIG. 13 is a diagram of a new channel structure of the PUCCH region for transmitting a small cell wake-up or detection support signal of a terminal.

FIG. 14 is a diagram of an operational process between a macro cell and a small cell through a transmission of a small cell wake-up or terminal detection signal using a macro cell frequency of the terminal.

FIG. 15 is a diagram illustrating a cell ID overlapping issue in a macro/small cell structure.

FIG. 16 is a diagram of a frame structure transmitted by a small cell base station including a synchronization channel.

FIG. 17 is an exemplary diagram of an application of a scrambling code to a configuration of a small cell-specific synchronization channel.

FIG. 18 is a diagram of different downlink/uplink configurations in the 3GPP TDD mode.

FIG. 19 is a diagram of a macro/small cell structure supporting a dual connectivity.

FIG. 20 is a diagram of a new frame structure for an uplink centralized transmission.

FIG. 21 is a diagram of a new TDD synchronization channel transmission frame structure for an uplink centralized transmission.

### DETAILED DESCRIPTION

The embodiments described herein are intended to clearly explain the concept of the present disclosure to those of ordinary skill in the art to which this disclosure pertains, not to limit the present disclosure thereto, and the scope of the disclosure should be construed to include modifications and variations that do not depart from the technical idea of the disclosure.

The accompanying drawings and terms used in this specification are intended to facilitate explanation of the present disclosure, and the shapes illustrated in the drawings are exaggerated as needed to aid in understanding of the present disclosure. Therefore, the present disclosure is not to be limited by the terms and accompanying drawings that are used herein.

Further, in the following description of the at least one embodiment, a detailed description of known functions and configurations incorporated herein will be omitted so as not to obscure the subject matter of the present disclosure.

Configuration, operation and other features of the present disclosure will be readily understood from embodiments of the present disclosure described herein with reference to the accompanying drawings. Some embodiments described below are example applications of technical features of the present disclosure to a wireless communication system. The wireless communication system may support at least one of SC-FDMA, MC-FDMA and OFDMA. Hereinafter, an exemplary description will be given of a method for allocating an additional reference signal over various channels. While the description of a 3GPP LTE channel will be basically given in this specification, examples in this specification may also be applied to a reference signal allocation method utilizing a control channel of IEEE 802.16 (or a revised version thereof) or control channels of other systems.

Acronyms used herein are as follows:

RE: Resource element

REG: Resource element group

CCE: Control channel element

CDD: Cyclic delay diversity

RS: Reference signal

CRS: Cell specific reference signal or cell common reference signal

CSI-RS: Channel state information reference signal

DM-RS: Demodulation reference signal

MIMO: Multiple input multiple output

PBCH: Physical broadcast channel

PCFICH: Physical control format indicator channel

PDCCH: Physical downlink control channel

PDSCH: Physical downlink shared channel

PHICH: Physical hybrid-ARQ indicator channel

PMCH: Physical multicast channel

PRACH: Physical random access channel

PUCCH: Physical uplink control channel

PUSCH: Physical uplink shared channel

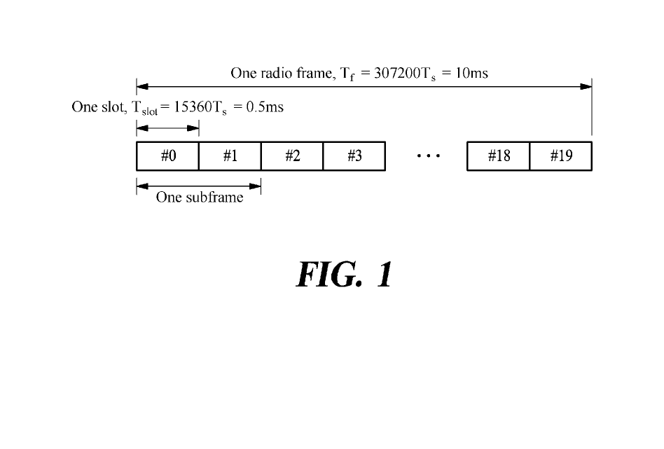

FIG. 1 is a diagram of the structure of a radio frame used in 3GPP LTE.

Referring to FIG. 1, a radio frame has a duration of 10 ms (327200×Ts) and includes ten equal-sized subframes. Each subframe has a duration of 1 ms and is composed of two slots. Each slot has a duration of 0.5 ms (15360×Ts). Herein, Ts denotes a sampling time, and is expressed as Ts=1/(15 kHz×2048)=3.2552×10-8 (about 33 ns). Each slot includes a plurality of OFDM symbols in time domain and a plurality of resource blocks in frequency domain. A transmission time interval (TTI), which is a unit time during which data is transmitted, may be defined by unit of at least one subframe. The structure of the radio frame described herein is merely illustrative. The number of subframes included in a radio frame, the number of slots included in a subframe, or the number of OFDM symbols included in a slot may be changed as necessary.

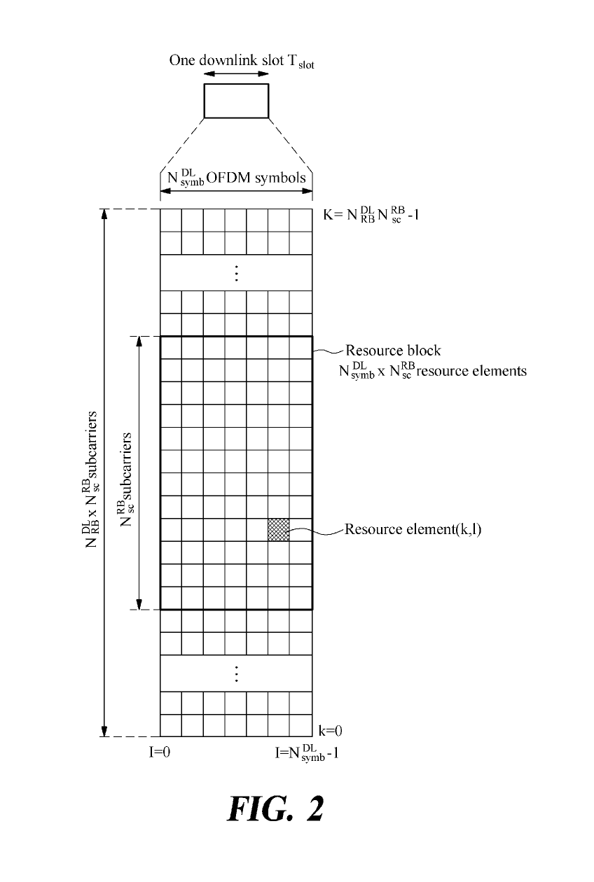

FIG. 2 is a diagram of a resource grid of one downlink slot. Referring to FIG. 2, a downlink slot includes NDLsymb OFDM symbols in time domain and NDLRB resource blocks in frequency domain. Each resource block includes NRBsc subcarriers, and thus one downlink slot includes NDLRB×NRBsc subcarriers in frequency domain. While FIG. 2 illustrates a downlink slot as including seven OFDM symbols and a resource block as including twelve subcarriers, embodiments of the present disclosure are not limited thereto. For example, the number of OFDM symbols included in a downlink slot may be changed depending on the length of a cyclic prefix (CP). Each element on the resource grid is called a resource element and is indicated by one OFDM symbol index and one subcarrier index. One resource block is made of NDLsymb×NRBsc REs. The number of resource blocks included in a downlink slot (NDLRB) depends on the downlink transmission bandwidth set in a cell.

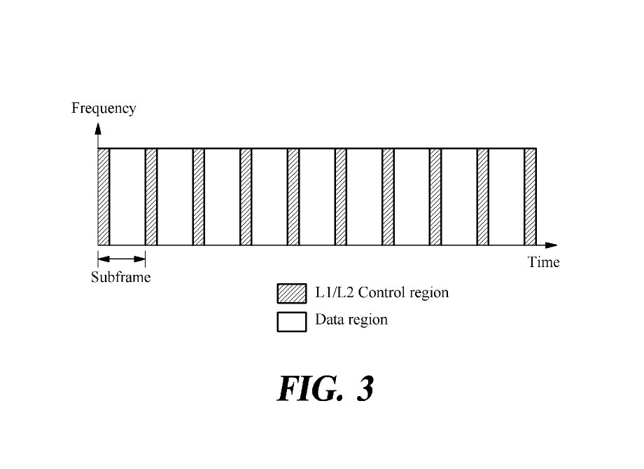

FIG. 3 is a diagram of the structure of a downlink radio frame.

Referring to FIG. 3, a downlink radio frame includes ten equal-sized subframes. Each subframe includes a Layer 1/Layer 2 (L1/L2) control region and a data region. Hereinafter, the L1/L2 control region will be simply referred to as a control region, unless specifically mentioned otherwise. The control region starts from the first OFDM symbol of a subframe and includes one or more OFDM symbols. The size of the control region may be independently set for each subframe. The control region is used to transmit an L1/L2 control signal. To this end, control channels such as PCFICH, PHICH and PDCCH are allocated to the control region. On the other hand, the data region is used to transmit downlink traffic. PDSCH is allocated to the data region.

An LTE terminal should perform the following processes before performing communications with an LTE network:

Acquisition of synchronization with a cell in the network; and

Reception and decoding of a cell system information which is needed for the terminal to properly operate in the cell while performing communication.

The terminal does not necessarily perform a cell search only when the terminal is turned on to access the system. To support mobility, the terminal needs to constantly seek synchronizations and estimate reception qualities of neighbor cells. The terminal evaluates the reception qualities of neighbor cells as compared to the reception quality of the current cell and uses the evaluation result in performing a handover (when the terminal in the RRC_CONNECTED mode) or cell reselection (when the terminal is in the RRC_IDLE mode).

The LTE cell search includes the following basic parts:

Acquiring frequency and symbol synchronizations for a cell;

Acquiring a frame synchronization of the cell, namely the start time of a downlink frame; and

Determining a physical layer cell ID of the cell.

In LTE, 504 different physical layer cell IDs are defined. Each cell ID corresponds to one specific downlink reference signal sequence. The physical layer cell IDs are divided into 168 cell ID groups, each including three cell IDs.

To aid the cell search, two special signals such as a primary synchronization signal (PSS) and a secondary synchronization signal (SSS) are transmitted on each downlink component carrier of LTE. The two synchronization signals have the same structure, but are located at different positions in a frame in time domain depending on whether the cell operates in FDD or TDD.

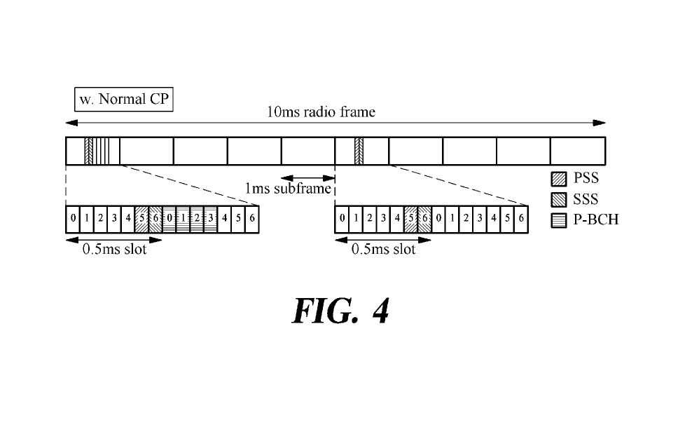

FIG. 4 is a diagram of the configuration of an FDD-based downlink synchronization channel in 3GPP LTE Release 8 and later versions.

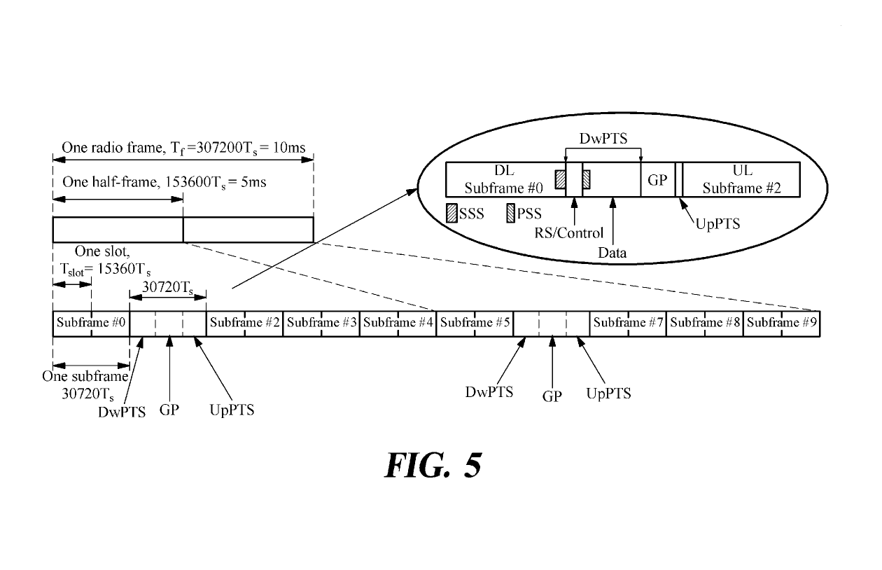

FIG. 5 is a diagram of the configuration of a TDD-based downlink synchronization channel in 3GPP LTE Release 8 and later versions.

In FDD, the PSS is transmitted on the last symbols of the first slots in subframes 0 and 5, and the SSS is transmitted on the second last symbols (i.e., the symbols immediately before the symbols for the PSS) of the same slots. In TDD, the PSS is transmitted on the third symbols (i.e., in DwPTS) of subframes 1 and 6, and the SSS is transmitted on the last symbols (i.e., three symbols before the symbols for the PSS) of subframes 0 and 5. Thereby, when the duplexing scheme in use is not known in advance, it may be identified by the positional difference between the synchronization signals.

The same PSS is transmitted twice per frame in a cell. In addition, the PSS of a cell may have three different values depending on the physical layer cell ID of the cell. More specifically, three cell IDs in a cell ID group correspond to different PSSs, respectively. Accordingly, the terminal recognizes 5 ms timing of the cell by detecting and confirming the PSS of the cell. Thereby, the terminal identifies the position of the SSS spaced a constant offset ahead of the PSS. In addition, the terminal identifies cell IDs in a cell ID group. However, the terminal is still unaware of the cell ID group, and thus the number of possible cell IDs is reduced from 504 to 168. Frame timing is identified by detecting the SSS (namely, the actual start point of a frame is identified between the two possible points found based on the PSS). In addition, the cell ID group (of 168 cell ID groups) is identified. For example, when a terminal searches cells on different carriers, the search window may be not be large enough to check two or more SSSs, and thus the terminal would be better to recognize the information as above, even if the terminal receives only one SSS. To this end, each SSS has 168 different values corresponding to 168 different cell ID groups. In addition, two SSSs in one frame (SSS1 in subframe 0 and SSS2 in subframe 5) have different values. This means that the terminal can identify whether SSS1 or SSS2 is detected once the terminal detects an SSS, and accordingly identify the frame timing. Once the terminal acquires the frame timing and the physical layer cell ID, it gains the identification of the corresponding cell-specific reference signal.

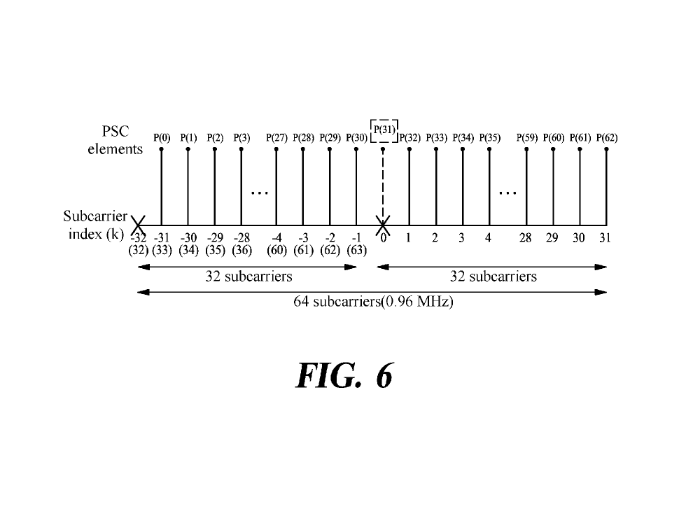

FIG. 6 is a diagram of frequency-domain mapping for a transmission of PSS.

Referring to FIG. 6, three different PSSs are three length-63 Zadoff-Chu (ZC) sequence. The k-th element c(k) of a ZC sequence indexed M may be expressed as follows.

$$\begin{matrix}c ( k ) = exp \{ - \frac{jπ Mk ( k + 1 )}{N} \} , when N is odd number \\ c ( k ) = exp \{ - \frac{jπ {Mk}^{2}}{N} \} , when N is even number\end{matrix} \qquad Equation 1$$

Herein, N is the length of the ZC sequence, index M is a natural number less than or equal to N, and M and N are relative primes. Three PSS IDs are determined based on three different indexes. A sequence extended by concatenating each of both ends of the ZC sequence with five Os is mapped to 73 subcarriers (6 resource blocks) in the middle of the whole band. It is noted that the center subcarrier is not actually transmitted since it is occupied by a DC subcarrier. Accordingly, only 62 values of the 63-length ZC sequence are actually transmitted. Therefore, the PSS occupies 72 middle resource elements excluding the DC subcarrier in subframes 0 and 5 in case of FDD and in subframes 1 and 6 in case of TDD.

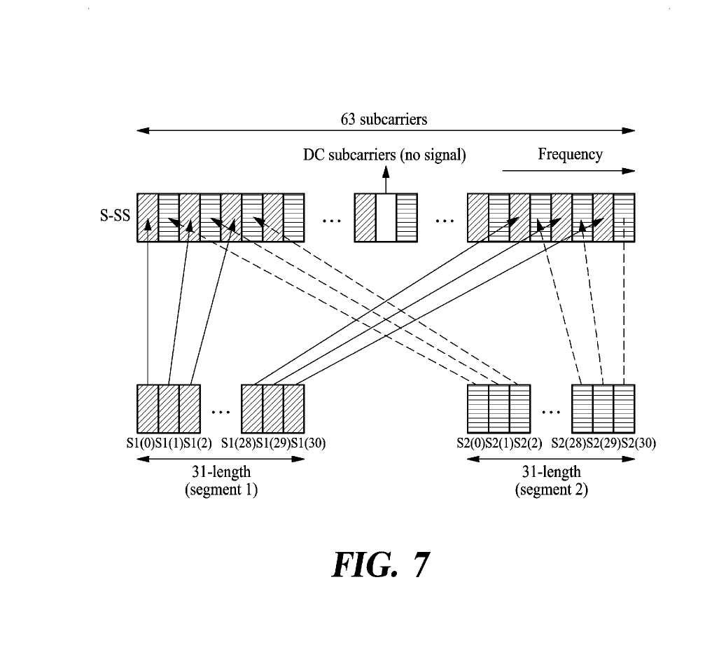

FIG. 7 is a diagram of frequency-domain mapping for a transmission of SSS.

Referring to FIG. 7, similar to the PSS, the SSS occupies 72 middle resource elements excluding the DC subcarrier in subframes 0 and 5 (in both FDD and TDD). SSS1 is based on a frequency interleaving of two length-31 m-sequences X and Y, each of which has 31 different values (actually 31 different shifts of the same m-sequence). SSS1 and SSS2 are based on the completely same two sequences in a cell, but the positions of the sequences are switched in frequency domain. A valid combination of X and Y for SSS2 is selected such that the two sequences with their positions switched in frequency domain do not establish a valid combination for SSS1. Accordingly, the number of valid combinations of X and Y for SSS1 for the purpose of detecting a physical layer cell ID is 168 (which is the same for SSS2). Additionally, the switching positions of sequences X and Y between SSS1 and SSS2 may be used to find the frame timing.

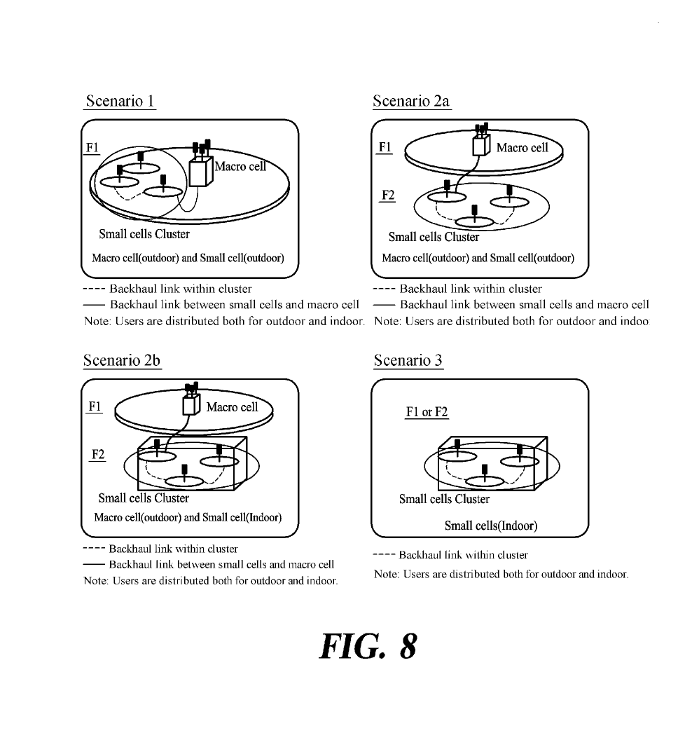

For the purpose of maximizing the user frequency efficiency on limited frequency resources, securing more subscribers to a service of the operator, improving the network management efficiency and maximizing the traffic processing capacity, a small cell-based cellular system has come into the spotlight. FIG. 8 shows common scenarios for small cells. According to 3GPP LTE TR36.923, main scenarios for small cells are broadly divided into four types according to whether a macro cell and small cells are located indoors/outdoors, whether different frequencies are used, and there is a backhaul link with the macro cell. In particular, scenario 2a or 2b is the core small cell scenario, in which small cells (or clusters) are controlled through a backhaul link with the macro cell, and operate at different frequencies to reduce an interference between the macro cell and the small cells.

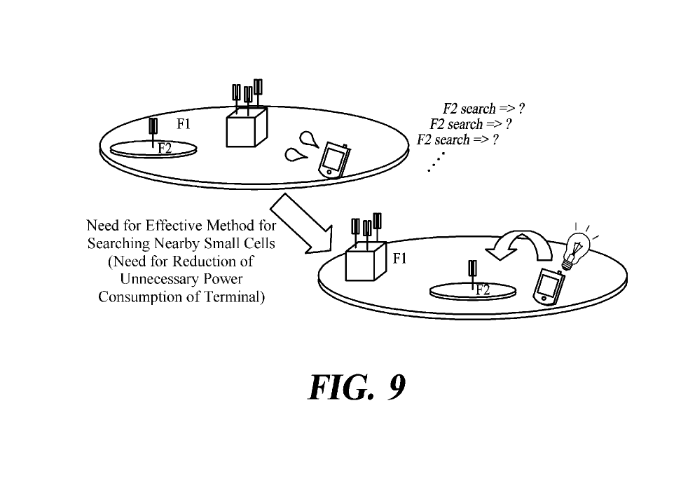

FIG. 9 is a diagram of a scenario in which unnecessary power consumption of a terminal occurs in a small cell search process.

Referring to FIG. 9, with the terminal served by a macro cell in a macro/small cell structure using different frequencies as in scenario 2a/2b of FIG. 8, periodically searching for a nearby small cell generates unnecessary power consumption for the search operation even without a nearby small cell. Preventively expanding the search period will cause a relatively delayed acquisition of the small cell search information, degrading the small cell usability.

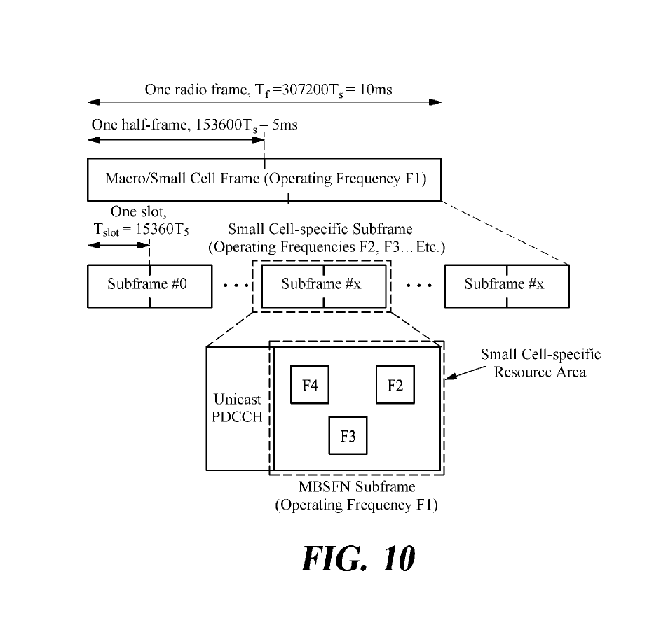

FIG. 10 is a diagram of a small cell search signal transmission structure of macro and small cells operating at different frequencies.

Referring to FIG. 10, suppose that the macro cell operates at frequency F1, and small cells operate at frequency F2. A terminal connected to the macro cell generally shifts to frequency F2 at a predetermined time to detect whether a small cell is present and to measure and transmit the signal strength of the small cell to a macro cell base station. However, the terminal may perform unnecessary operations at a specific time without a small cell present nearby. Accordingly, to allow the terminal connected to the macro cell F1 to search a small cell of a different frequency as shown in FIG. 10, a small cell-specific resource interval is set. A legacy terminal also attempts to access the macro cell, and therefore an MBSFN subframe allocation method may be used to set an interval specific to small cells without affecting the legacy terminal. In the small cell-specific resource region secured in this way, a small cell base station operating at a different frequency shifts to F1 at a corresponding time and transmits the small cell signals through the resource region of the macro cell. In this case, resources may be subdivided by and assigned to each frequency such that different small cells are grouped to transmit the signals, or a common region may be used after dividing by a spread code, or the same signal may be transmitted. If a searchable information of the small cell is transmitted in the F1 region of the macro cell as above, a terminal linked to the macro cell may obtain an information on a small cell of an operational frequency different from the frequency at which the terminal is currently served, without performing frequency shift. Accordingly, if the terminal acquires an information on the presence of a small cell or additional information at a corresponding frequency, the terminal can shift to the frequency and perform inter-frequency measurement. Thereby, unnecessary power consumption may be reduced.

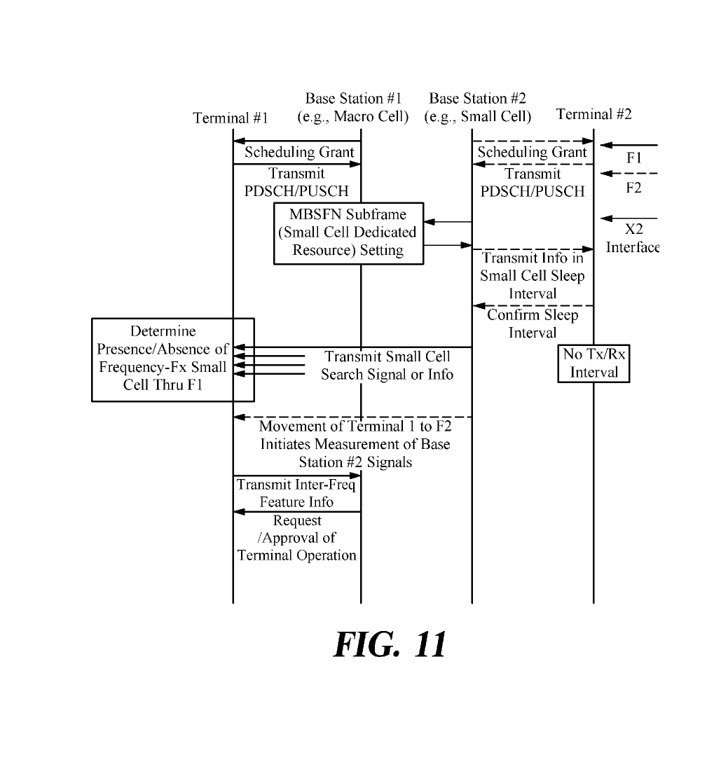

FIG. 11 is a diagram of a series of processes for small cell search of a terminal utilizing small cell-specific resources proposed in a macro/small cell environment.

Referring to FIG. 11, terminal #1 connected to the macro cell may secure an allocation of resources that do not affect the legacy terminals by using an MBSFN subframe in a specific time period (e.g., one subframe) set up between the macro cell and a small cell. The small cell may share the corresponding information in a prearrangement with its connected terminal to shift the service interruption interval of the small cell to frequency F1 of the macro cell cooperatively under the prearrangement. The macro-connected terminal may determine the presence/absence of the small cell and transmit the presence/absence information on a small cell-specific resource to acquire an additional small cell information.

MBSFN subframes of this kind can be constantly secured with a period of, for example, 40 msec, and accordingly the small cell-specific resources may be periodically secured such that the terminal can secure a corresponding time to make detections without additional signaling.

The MBSFN subframe-based support to the small cell search provides the function of facilitating the small cell search by the terminal using downlink resources. Additionally, from the perspective of the small cell base station, if the terminal is not present within a small coverage, persistent transmissions of synchronization/system information may degrade the power efficiency of the small cell, thereby significantly increasing overall power consumption of the system in an environment where there are a large number of small cells. To overcome this problem, the small cells may need to operate in a low-duty mode. If there is no terminal supported by the small cells, they are better asleep or turned off except when they perform minimized information transmission. With the small cell operating in the low-duty mode, if a terminal is present within the coverage of the small cell, the terminal needs to wake up the small cell for relaying services to receive. However, if the macro and small cells utilize different frequencies, it is not desirable, either for the terminal to shift to a specific frequency for transmitting a wake-up signal, or for the small cell to persistently consume power for detecting a terminal signal.

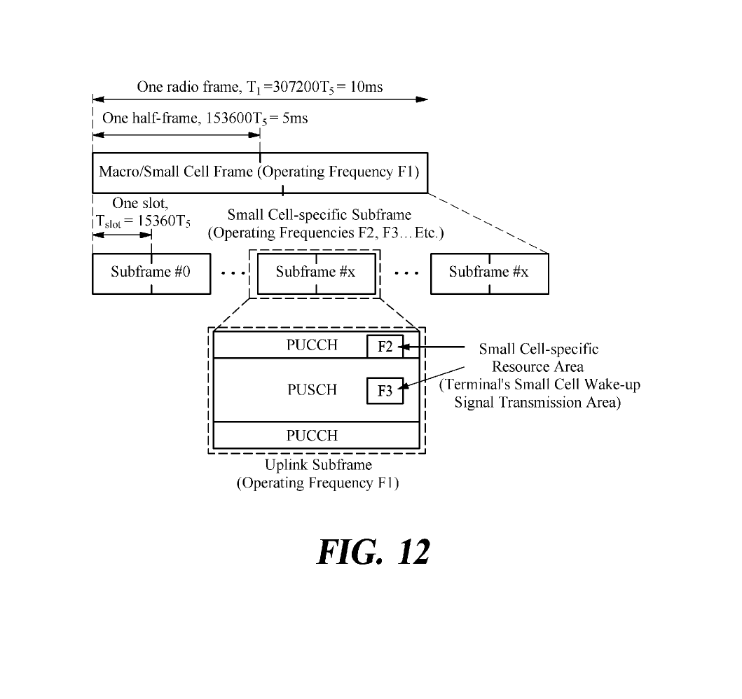

FIG. 12 is a diagram of a macro/small cell transmission structure based on a terminal supported wake-up signal transmission.

Referring to FIG. 12, with the small cell operating in the low-duty mode or supporting a terminal access, a terminal may determine the presence/absence of an additional terminal or a new terminal or transmit the presence determination over a specific uplink resource to wake up a small cell at a specific frequency. As shown in the figure, in the PUCCH region where the terminal coexists with legacy terminals, it is better to secure resources on which the terminal can coexist with the legacy PUCCH format and only small cells are allowed to search signals of the terminal. The PUSCH is a resource that can be exclusively used by the terminal, and resources for terminals supporting a small cell in the macro cell may be allocated to transmit various kinds of information through a PUSCH operation.

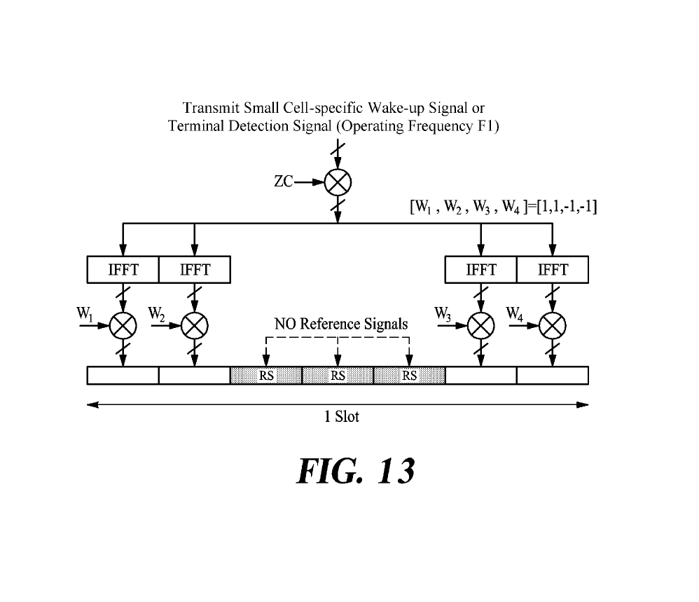

FIG. 13 is a diagram of a new channel structure of the PUCCH region for transmitting a small cell wake-up or detection support signal of a terminal.

To implement the small cell interference control as above, an information transmission channel is needed for directly or indirectly measuring an interference information. To obtain functions capable of coexisting with terminals for 3GPP LTE Release 8 and a later version and transmitting differentiated additional information, it is appropriate to find resources for making the best reuse of the conventional legacy system while allowing an additional channel allocation. According to 3GPP TS 36.211 V11.1.0 (2012-12) “Evolved Universal Terrestrial Radio Access (E-UTRA); Physical Channels and Modulation (Release 11)”, the legacy PUCCH format 1 uses a length-4 orthogonal code to apply time-domain spread to a 4-OFDM symbol interval for ACK/NACK or SR transmission, and uses a length-3 orthogonal code for time-domain spread of the RS region. The orthogonal codes used in this case are shown in Tables 1 and 2. As can be seen from the tables, for PUCCH format 1, the number of symbols in the RS transmission interval differs from that in the information transmission interval, and one of length-4 orthogonal codes is not used in order to maintain one-to-one mapping between time-domain spread codes. In other words, a selective one-to-one mapping of three sequences of sequence indexes 0, 1 and 2 is maintained between length-4 and length-3 orthogonal codes, as shown in Tables 1 and 2. Accordingly, the length-4 orthogonal code [+1 +1 −1 −1] can be used for an extra purpose.

TABLE 1

| Sequence index | Orthogonal sequences (length 4) |
|---|---|
| 0 | [+1 +1 +1 +1] |
| 1 | [+1 −1 +1 −1] |
| 2 | [+1 −1 −1 +1] |

TABLE 2

| Sequence index | Orthogonal sequences (length 2) |
|---|---|
| 0 | [+1 +1 +1] |
| 1 | [1 e^{j2π/3} e^{j4π/3}] |
| 2 | [1 e^{j4π/3} e^{j2π/3}] |

The additional length-4 time-domain spread code is difficultly mapped by the length-3 spread code for the RS as above, and therefore the transmission of the interference information can be achieved by transmitting the aforementioned wake-up signal or terminal detection signal information as the energy/power level through a modulation technique in consideration of a non-coherent or other demodulation schemes, or transmitting an interference information on a limited level (e.g., 1 to 2-bit information) after a demodulation.

Legacy PUCCH Format 1 may be reused, and [+1 +1 −1 −1], which is currently not in use, may be used as a time-domain spread code to transmit an interference information, a control information and the like which are suitable for the small cell. As can be seen in FIG. 13, the RS uses all three DFT codes in PUCCH Format 1, and thus a corresponding new length-4 channel may be transmitted without the RS. In addition, the transmission of the small cell-specific control information may be achieved by transmitting the aforementioned user signal detection signal, or by transmitting a terminal presence/absence acquisition information by way of power/energy level wherein the degree of interference is a measure of the sum of power/energy levels transmitted by a plurality of terminals. Further, any control information of a few bits may be transmitted through a demodulation technique such as M-QAM.

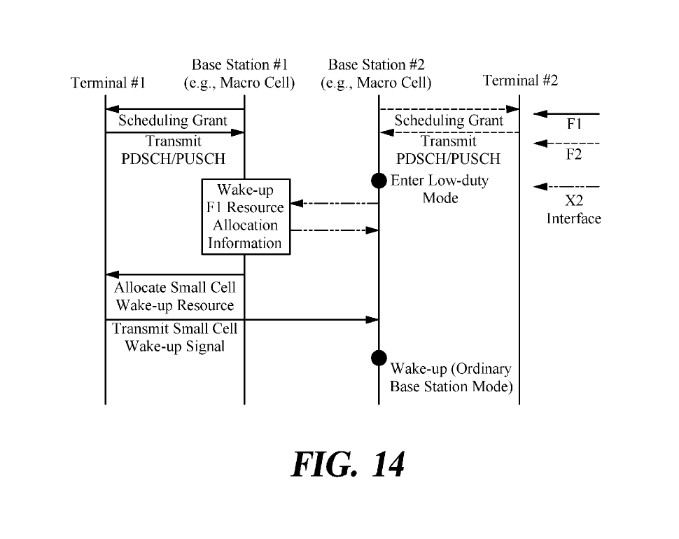

FIG. 14 is a diagram of an operational process between a macro cell and a small cell through a transmission of a small cell wake-up or terminal detection signal using a macro cell frequency of the terminal.

Referring to FIG. 14, upon receiving a specific uplink resource allocated in a prearrangement with the macro cell, the terminal transmits the allocation information at a predetermined time, when a small cell operating at a different frequency shifts to a macro cell frequency F1 and detects the transmitted signal of the terminal at this time. Thereby, the small cell may determine whether there is a terminal therearound and whether a request is made for waking up the base station in the low-duty mode at a specific frequency.

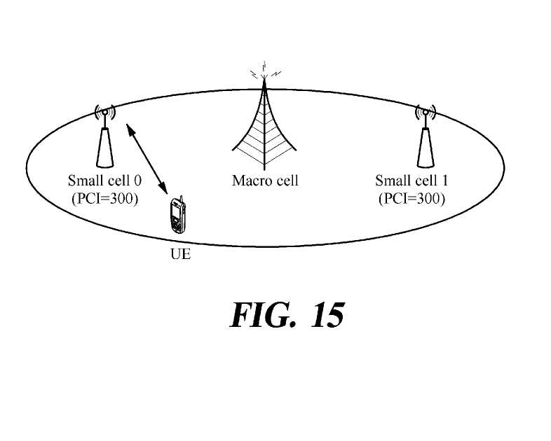

FIG. 15 is a diagram illustrating a cell ID overlapping issue in a macro/small cell structure.

Referring to FIG. 15, suppose that a terminal or user equipment (UE) connected to the macro cell acquires a cell ID (physical cell ID, PCID or PCI) information about a neighbor small cell to transmit an inter-frequency measurement (e.g., PCI=300). If the ID of the small cell is arbitrarily set in the presence of a large number of small cells, the ID of the small cell may become redundant in a macro cell. In this case, it is difficult for the macro cell to determine which small cell base station the terminal attempts to access. Thereby, it is difficult to support the corresponding terminal through a proper small cell. This problem occurs not only in the same macro cell but also in a small cell which is in another neighbor macro cell.

Suppose that no two small cells remain in one macro cell to have the same cell ID thanks to the effective solution to this problem, including maintaining a synchronization between base stations, presuming the macro and small cells have a backhaul-linked structure, and enabling the macro cell to control the small cells (if the identical cell IDs are assigned, it is appropriate to make a request for cell ID change by the macro cell base station having received corresponding information through the backhaul).

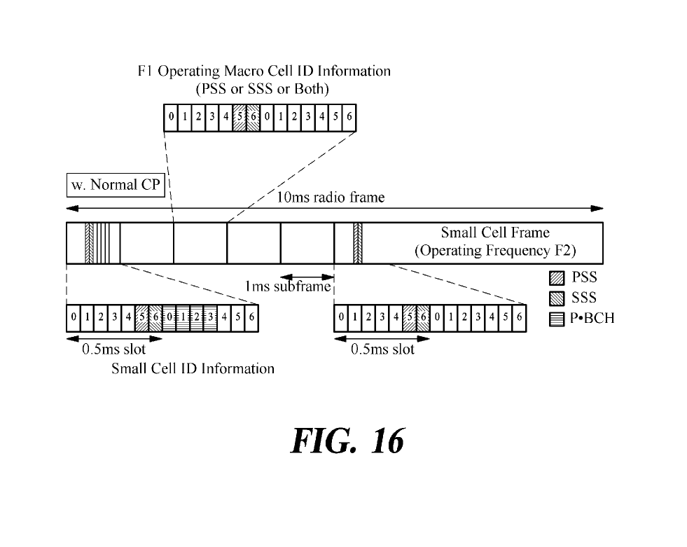

FIG. 16 is a diagram of a frame structure transmitted by a small cell base station including a synchronization channel.

Referring to FIG. 16, a small cell synchronization channel transmits a cell ID while maintaining the legacy PSS/SSS transmission structure. Upon detecting the cell ID, the terminal transmits, to its connected macro cell, a cell ID and measurement information measured at the frequency of the small cell. In this process, it is difficult to determine whether the small cell is in the same macro cell, and if there are small cells having the same cell ID between macro cells, it is difficult for the base station to distinguish between the small cells. Accordingly, in the process of transmitting a synchronization channel to a frame at frequency F2 in the small cell region as shown in FIG. 16, all or a part of the cell ID information of a macro cell is transmitted through a predetermined resource of a specific subframe. Thereby, the ID of a small cell may be configured in the paired form of (macro cell ID, small cell ID), and when the terminal transmits an inter-frequency measurement information to a macro base station, the terminal may transmit the corresponding cell ID pair at the same time, or may selectively transmit a small cell ID identical to the macro cell ID. In the process of transmitting the macro cell ID information through a small cell, PSS/SSS information of the macro cell ID may be transmitted in its entirety. Alternatively, only PSS or SSS may be transmitted. The more limited information transmitted, the more probable the neighbor cells overlap. This will put an additional burden on an operator when carrying out cell planning. In addition, a processed information of a macro cell ID may be transmitted. The current cell ID is used to control an interference between neighbor cells along with the frequency shift of a common reference signal, and six shift elements are provided to avoid collision between neighbor cells. Accordingly, a macro cell information delivered through a small cell may be processed to deliver a computed value of (macro cell ID mod 6).

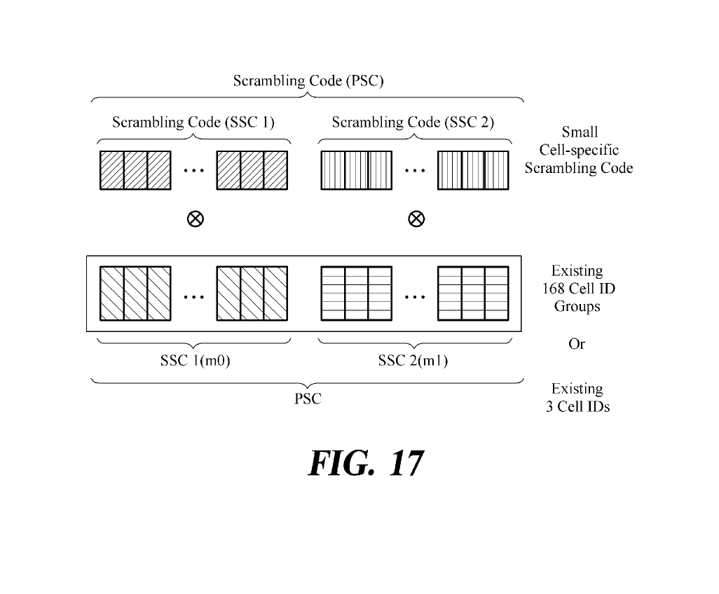

FIG. 17 is an exemplary diagram of an application of a scrambling code to a configuration of a small cell-specific synchronization channel.

Referring to FIG. 17, an evolved terminal different from the legacy terminals may search through small cells for the relevant small cell, and a scrambling code may be applied to the legacy terminals to prevent them from detecting the PSS of the small cell to thereby prevent a further operational error of the legacy terminals. This operation is equally applicable to the SSS. Further, in order to prevent an erroneous operation of the terminal when partial/all/processed information of the macro cell ID is transmitted as shown in FIG. 16, a scrambling code may be additionally applied.

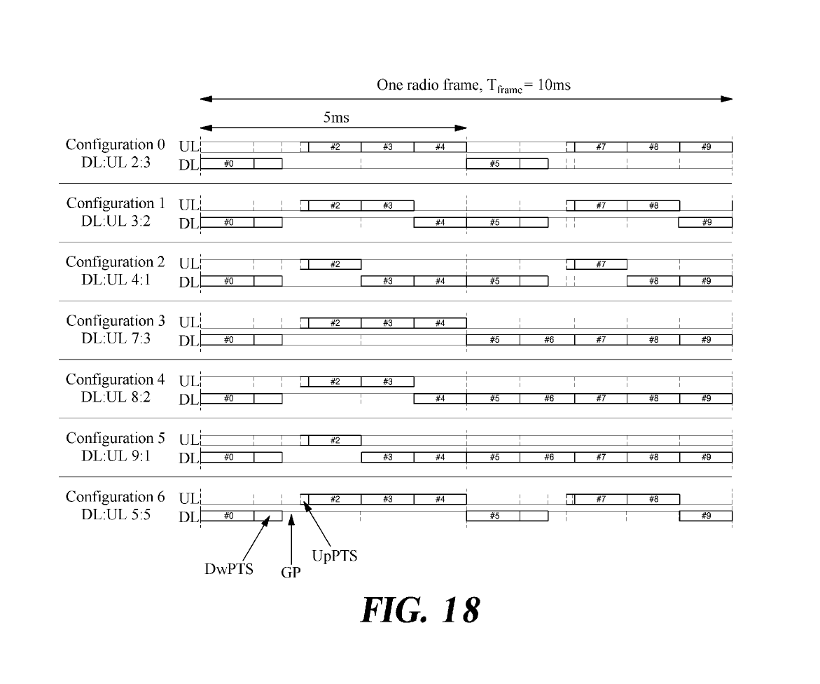

FIG. 18 is a diagram of different downlink/uplink configurations in the 3GPP TDD mode.

In TDD operation, only one carrier frequency is provided, and thus uplink transmission is distinguished from downlink transmission in time with respect to one cell. As can be seen from FIG. 18, some subframes are allocated to downlink transmission, some other subframes are allocated to uplink transmission, and switching between the downlink and uplink occurs in a special subframe (subframe 1 and, in a specific case, subframe 6). Depending on the amount of resources allocated to the downlink and uplink transmissions, various downlink/uplink asymmetrical configurations may be provided, which is performed through seven possible downlink/uplink configurations as shown in Table 3. Subframes 0 and 5 are invariably allocated to downlink transmission, and subframe 2 is invariably allocated to uplink transmission. The other subframes (except the special subframe) may be allocated to the downlink and uplink transmission as desired, depending on the downlink/uplink configuration.

Table 3 illustrates a TDD downlink/uplink configuration method.

TABLE 3

| Con- | Switch- | | | | | | | | | | |
|---|---|---|---|---|---|---|---|---|---|---|---|
| figu- | point | Subframe Number | | | | | | | | | |
| ration | Periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 10 ms | D | S | U | U | U | D | S | U | U | D |

Referring to FIG. 18, in the case of 3GPP TDD, there are seven supportable DL/UL ratios of (2:3), (3:2), (4:1), (7:3), (8:2), (9:1) and (5:5). Most of the ratios are designed such that the proportion of downlink DL is higher. This was intended to support the relatively large amount of downlink traffic transmission in supporting both the uplink and downlink on one carrier due to the nature of the TDD. If small cells are supported, however, “dual connectivity” is given for supporting the macro cell and the small cells at the same time at different frequencies as mentioned above in small cell scenario 2a or 2b.

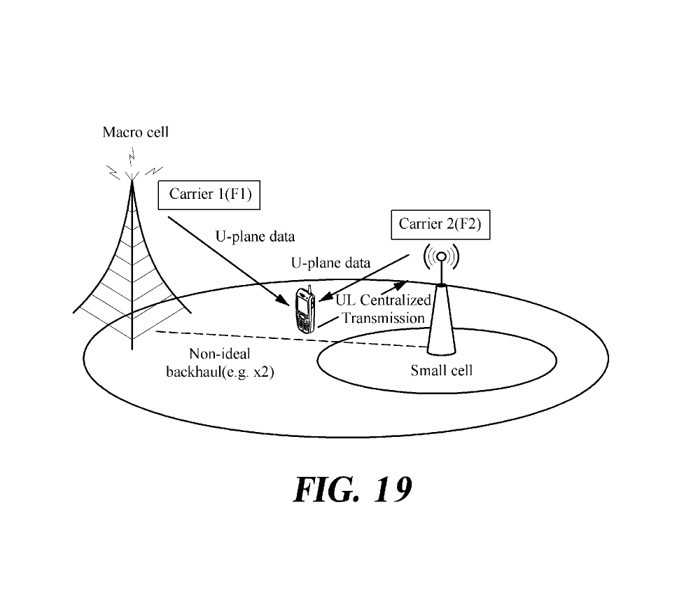

FIG. 19 is a diagram of a macro/small cell structure supporting a dual connectivity.

Referring to FIG. 19, the macro/small cell structure involves an unbalanced signal strength of the terminal resulting from differences in coverage and transmit power. In this case, the downlink and uplink have different characteristics from the perspective of the terminal. For example, according to an RSRP-based cell selection method, the macro cell may be more suitable for downlink than the small cells. For the uplink, on the other hand, traffic may be better transmitted through a neighbor small cell. Accordingly, when a macro cell and small cells are taken into account, an uplink centralized transmission method needs to be carefully designed. As shown well in FIG. 19, it is appropriate to have the macro cell and the small cell use different frequencies and keep the uplink/downlink frequencies unseparated while designing a TDD-based uplink centralized frame structure on a single carrier.

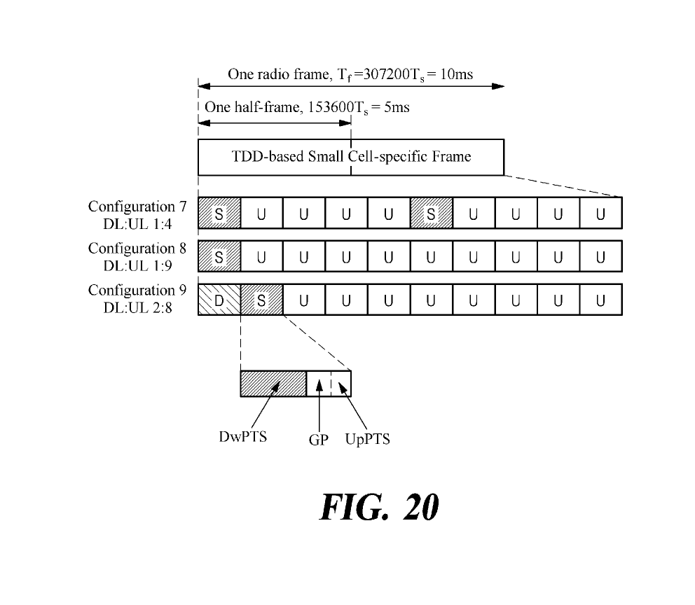

FIG. 20 is a diagram of a new frame structure for an uplink centralized transmission.

As shown in FIG. 20, the DL region is minimized for the uplink centralized transmission, and frame structures with (1:4), (1:9) and (2:8) is proposed in consideration of 5 msec and 10 msec given as periods. In the legacy TDD, subframes 0 and 5 were supposed to be always allocated as downlink-dedicated subframes. This is because of the configuration of a synchronization channel to span two subframes as shown in FIG. 5, and the constant need for the downlink-dedicated subframes except the special subframe. However, if the number of symbols of DwPTS is greater than or equal to 10 as shown in the table given below, the synchronization channel may be transmitted through the relevant DL region, a minimized number of downlink resources may be configured, and thereby a maximum number of resources may be allocated to the uplink data transmission.

Table 4 shows a configuration of DwPTS, UpPTS, and GP.

TABLE 4

| | DwPTS | | | | | | | | |
|---|---|---|---|---|---|---|---|---|---|
| | 12 | 11 | | 10 | | 9 | | 3 | |
| GP | 1 | 1 | 2 | 2 | 3 | 3 | 4 | 9 | 10 |
| UpPTS | 1 | 2 | 1 | 2 | 1 | 2 | 1 | 2 | 1 |

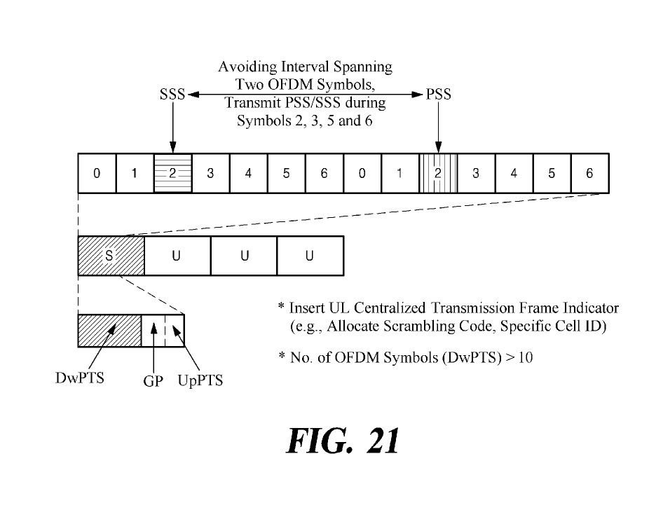

FIG. 21 is a diagram of a new TDD synchronization channel transmission frame structure for an uplink centralized transmission.

As shown in FIG. 21, a new synchronization channel may not use the two legacy subframes, but be transmitted through one special subframe, and the PSS and SSS are appropriately transmitted through symbols 2, 3, 5 and 6 which are out of the PDCCH and CRS transmission region. The PSS and the SSS are appropriately set to have respective symbol spaces not equal to two symbols. For the synchronization channel transmission in the modified new frame structure as above, an additional indicator needs to be inserted in the PSS/SSS to distinguish the terminal or frames from the legacy terminal or the existing TDD frames. In this case, as shown in FIG. 17, the distinguishing may be performed through a specific scrambling code, or a specific sequence or pattern of PCID may be allocated to allow only terminals capable of searching the new frame structure to acquire the relevant synchronization channel.

### CROSS-REFERENCE TO RELATED APPLICATION

If applicable, this application claims priority under 35 U.S.C §119(a) of Patent Application No. 10-2013-0048983 and Patent Application No. 10-2013-0048985, commonly filed on Apr. 30, 2013 in Korea, the entire contents of which are incorporated herein by reference. In addition, this non-provisional application claims priorities in countries, other than the U.S., with the same reason based on the Korean Patent Applications, the entire contents of which are hereby incorporated by reference.

1. A method for configuring a frame in a communication system supporting an uplink centralized transmission, the method comprising:
generating a frame by periodically allocating an uplink/downlink switch subframe; and
allocating all subframes to uplink as uplink-dedicated subframes except the uplink/downlink switch subframe without a downlink-dedicated subframe.

2. The method of claim 1, wherein a period of the periodically allocating of the uplink/downlink switch subframe is defined as 5 msec or 10 msec.

3. The method of claim 1, wherein eight or nine of the uplink-dedicated subframes are allocated in the frame.

4. The method of claim 1, wherein the number of downlink symbols in the uplink/downlink switch subframe is greater than or equal to 10.

5. The method of claim 1, wherein all downlink synchronization information is transmitted within the uplink/downlink switch subframe.

6. The method of claim 1, further comprising:
generating a synchronization signal by selecting two downlink symbols from among downlink symbols allocated in the subframes.

7. The method of claim 6, wherein the synchronization signal has a transmission symbol which is transmitted through symbols unused for transmissions of a downlink control signal and a reference signal.

8. The method of claim 7, wherein the transmission symbol of the synchronization signal is selected from among symbol indexes 2, 3, 5 and 6.

9. The method of claim 6, wherein the synchronization signal comprises a 3GPP PSS and SSS having respective symbol spaces not equal to two symbols.

10. The method of claim 6, wherein the transmission symbol of the synchronization signal contains an information indicating an uplink centralized subframe.
